(19) United States
(12) Patent Application Publication
(10) Pub. No.: US 2016/0229085 A1
(43) Pub. Date: Aug. 11, 2016

(54) APPARATUS AND METHOD FOR FRACTURING SOLID MATTER

(71) Applicant: Posillico Inc., College Point, NY (US)

(72) Inventor: William S. Bisceglia, College Point, NY (US)

(73) Assignee: Posillico Inc., College Point, NY (US)

(21) Appl. No.: 15/015,324

(22) Filed: Feb. 4, 2016

Related U.S. Application Data
(60) Provisional application No. 62/112,424, filed on Feb. 5, 2015.

(51) Int. Cl. B28D 1/32; B26F 3/00

(52) U.S. Cl. CPC B28D 1/32; B26F 3/00

(57) ABSTRACT

The disclosure is directed to an apparatus and method for fracturing solid matter. The apparatus including an elongated element, the elongated element including a first end and a second end, wherein the first end and the second end are wider than the elongated element and wherein an intermediate portion of the elongated element is formed between the first end and the second end, wherein the intermediate portion is configured to contain a first liquid between the solid matter and the elongated element; and a conduit configured to convey a second fluid, wherein the second fluid is at a temperature below a freezing temperature of the first fluid, wherein a portion of the conduit passes through the intermediate portion.

### CROSS REFERENCE To RELATED APPLICATION

This application claims the benefit of priority from U.S. Provisional Application No. 62/112,424, filed on Feb. 5, 2015, the content of which in its entirety is incorporated herein by reference.

### BACKGROUND OF THE DISCLOSURE

There are a variety of means and methods to fracture and break concrete and rock throughout the construction industry. The most common means and methods are as follows.

1. Drilling and Blasting

2. Hydraulic Hammering

3. Drilling and Hydraulic Hammering

4. Drilling and Mechanical Splitting

5. Drilling and Chemical Expansion Grouting

Each of the above listed means and methods have comparable advantages and disadvantages with respect to cost, time, safety, site logistics, vibration, noise and regulations at the City, State and Federal level.

There is a need for a new type of apparatus and method to fracture and break concrete and rock that can achieve one or more of the following objectives, a reduced cost, a reduced fracture time, a safer fracturing procedure, an ability to operate in limited spaces, a reduced vibration, a reduced noise output and compliance with relevant regulations at the City, State and Federal level.

Therefore, what is desired is a device and method with the ability to fracture or break concrete and rock that is inexpensive, relatively quick, safe, with little vibration and noise. Embodiments of the present disclosure provide devices and methods that address the above and other issues.

### SUMMARY OF THE DISCLOSURE

The present disclosure is directed to an apparatus and method for fracturing solid matter.

The apparatus configured to fracture the solid matter comprises an elongated element, the elongated element comprising a first end and a second end, wherein at least one of the first end and the second end are wider than the elongated element and wherein an intermediate portion of the elongated dement is formed between the first end and the second end, wherein the intermediate portion is configured to contain a first liquid between the solid matter and the elongated element and a conduit configured to convey a second fluid, wherein the second fluid is at a temperature below a freezing temperature of the first fluid, wherein a portion of the conduit passes through the intermediate portion.

The method for fracturing solid matter comprises inserting an elongated element into an opening of the solid matter, the elongated element comprising a first end and a second end, wherein at least one of the first end and the second end are wider than the elongated element and wherein an intermediate portion of the elongated element is formed between the first end and the second end, wherein the intermediate portion is configured to contain a first liquid between the solid matter and the elongated element and conveying a second fluid through a conduit for a period of time, wherein the second fluid is at a temperature below a freezing temperature of the first fluid and wherein a portion of the conduit passes through the intermediate portion.

### BRIEF DESCRIPTION OF THE DRAWINGS

The present disclosure will be better understood by reference to the following drawings of which:

FIG. 1 is perspective view of an apparatus inside a glass;

FIG. 2 is a top view of the apparatus of FIG. I after the glass has broken;

FIG. 3 is a perspective view of an apparatus and conduit;

FIG. 4 is a perspective view of an apparatus and conduit inserted into an opening of a concrete block;

FIG. 5 is a perspective view of a fracture formed in the concrete block of FIG. 4;

FIG. 6 is a perspective view of the apparatus and conduit of FIG. 5 removed from the fractured concrete block;

FIG. 7 is a perspective view of an apparatus inserted in an opening of a boulder;

FIG. 8 is a perspective view of an apparatus inserted in an opening of a fractured boulder;

FIG. 9 is a perspective view of an apparatus before insertion into an opening of a boulder;

FIG. 10 is a perspective view of an apparatus and sleeve before insertion into an opening of a boulder; and

FIG. 11 is a perspective view of an apparatus and sleeve just prior to insertion into an opening of a boulder.

### DETAILED DESCRIPTION OF THE DISCLOSURE

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat.

As used herein, the term “about” indicates that the value listed may be somewhat altered, as long as the alteration does not result in nonconformance of the process or structure to the illustrated embodiment. For example, for some elements the term “about” can refer to a variation of ±0.1%, for other elements, the term “about” can refer to a variation of ±1% or ±10%, or any point therein.

The present disclosure includes an apparatus for fracturing a solid matter. This apparatus includes a device for freezing a first fluid in a drilled or formed hole within an solid matter, such as rock and/or concrete. Although rock and concrete are used herein when referring to the figures, these terms are for exemplary purposes only. The discussed apparatus and methods can be used on any solid matter including, for example, cement, concrete and other aggregate materials, and rock and other mineral formations. Further, although specific dimensions are discussed in reference to the apparatus and the opening formed in the solid matter, other suitable dimensions for both the apparatus and the opening formed in the solid matter are also contemplated in this disclosure.

A substantially solid, elongated element having a length, such as a pipe, bolt, rod, conduit, or any element that is substantially solid with a suitable length, can include a first end and a second end, at least one of which is wider than the elongated element. The first end and the second end form an intermediate portion between the first end and the second end of the elongated element. The first end and/or the second end can themselves be wider, or something can be attached to at least one end of the elongated dement to cause the first end and/or the second end to be wider.

Within this intermediate portion a first fluid that can be frozen at a temperature of greater than about −320° F. can be provided. This first fluid can be any suitable fluid or liquid, such as, for example, water, and water mixed with other particulates or dissolved elements. The first fluid can be provided by pouring; or otherwise causing to flow, the first fluid into the opening formed in the solid matter prior to inserting the elongated element into the opening, or while the elongated element is already inserted into the opening such that the first fluid flows around the first end of the elongated element into the intermediate portion.

The elongated element is proportioned to fit within an opening, such as a drill hole or existing break or crack in a solid matter, such as a rock. The intermediate portion is proportioned such that the distance between the intermediate portion and the solid matter is greater than the distance between at least one of the first end of the elongated member and the second end of the elongated member.

At least one of the first end and the second end of the elongated element are proportioned to be in contact or be about or nearly the same size as the opening in the rock. Because of these proportions, the first fluid near the first end and/or the first fluid near the second end freezes or substantially freezes before the first fluid in the intermediate portion. Due to the earlier freezing near at least one of the first end and the second end, the frozen portions substantially restrict expansion along the axis of the elongated element of the first fluid that is remaining in the intermediate portion. Because expansion of the first fluid is restricted along the axis of the elongated element, expansion occurs perpendicularly or substantially perpendicularly to the elongated portion.

Also included with the apparatus is a conduit that is configured to pass a second fluid therethrough. In the context of this application the term fluid refers to fluids, gasses and mixtures of fluids and gasses. The conduit extends past the first end of the elongated element, such that at least a portion of the conduit passes through the intermediate portion formed by the first and second ends of the elongated element

The second fluid in the conduit is at a temperature below a freezing temperature of the first fluid. In one embodiment the second fluid is a fluid having a boiling point temperature lower than the freezing temperature of the first fluid. In another embodiment the second fluid is a fluid that is capable of substantially maintaining a temperature lower than the freezing temperature of the first fluid. As referred to herein, “freezing” refers to a phase change of the first fluid and relative expansion in volume created by that phase change.

The conduit can be configured to wrap around a portion of the elongated element or the conduit can follow any suitable pattern within the intermediate portion. A first end of the conduit can be connected to a second fluid supply such that the conduit conveys a second fluid through the conduit, from the first end of the conduit and out a second end of the conduit. The second end of the conduit is configured to be outside the opening formed in the solid matter.

An optional sleeve can also be included with the apparatus. This sleeve, which is substantially pressure resistant and a substantially elastic material, can be placed over the exterior of the first end and the second end of the elongated element and substantially separate the intermediate portion from the surface of the solid matter that is to be fractured. This sleeve can be any suitable substantially pressure resistant and substantially elastic material, such as a portion of a hose, such as a fire hose.

This sleeve is added prior to the elongated element and conduit being introduced into the solid matter. This sleeve can reduce the amount of first fluid from leaching or dispersing into the solid matter the apparatus is placed in.

Some non-limiting examples of the disclosure are discussed below.

### EXAMPLE 1

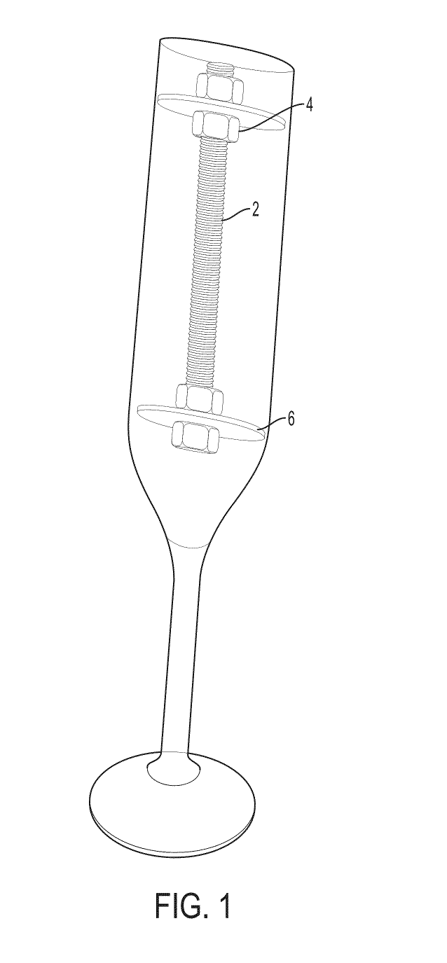

A fluted glass was filled with water is shown in FIG. 1. In this example the glass is used to demonstrate the operation of the device and is in place of the rock or other solid matter. In the example shown in FIG. 1, a threaded bolt 2 (length equal to the height of the liquid, in this example, water), acting as an elongated element, with a washer 4 acting as a first end and a washer 6 acting as a second end, the diameter of the washers being equal to just less than the interior diameter of the glass, are secured at the top and bottom of the bolt 2. The bolt 2, with washers 4 and 6, was placed in the glass and the glass was filled with water, as shown in FIG. 1. The glass was placed in a freezer until the water was frozen.

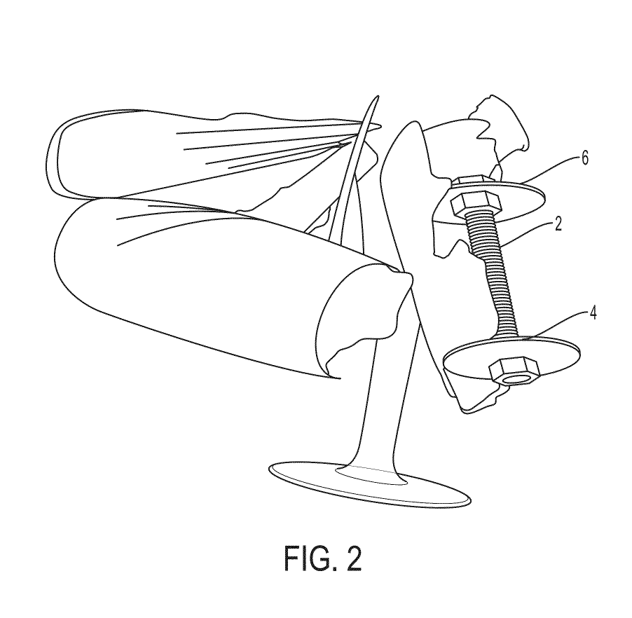

In this example, as the water froze, ice initially expanded vertically past the edge of top washer 4 a relatively small distance and then substantially stopped expanding vertically. After a time, the water held within the intermediate portion (portion between washer 4 and washer 6) of the bolt 2 expanded horizontally and fractured the fluted glass walls, the results of which are shown in FIG. 2.

### EXAMPLE 2

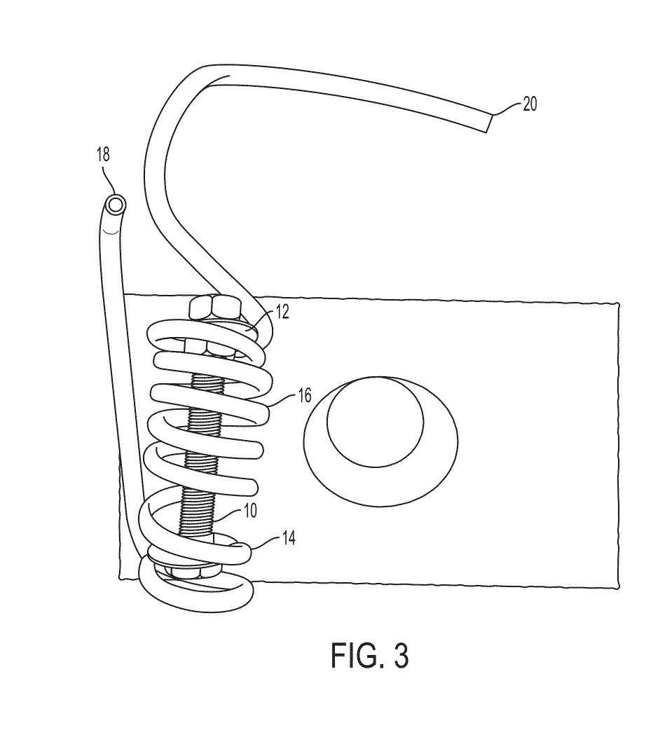

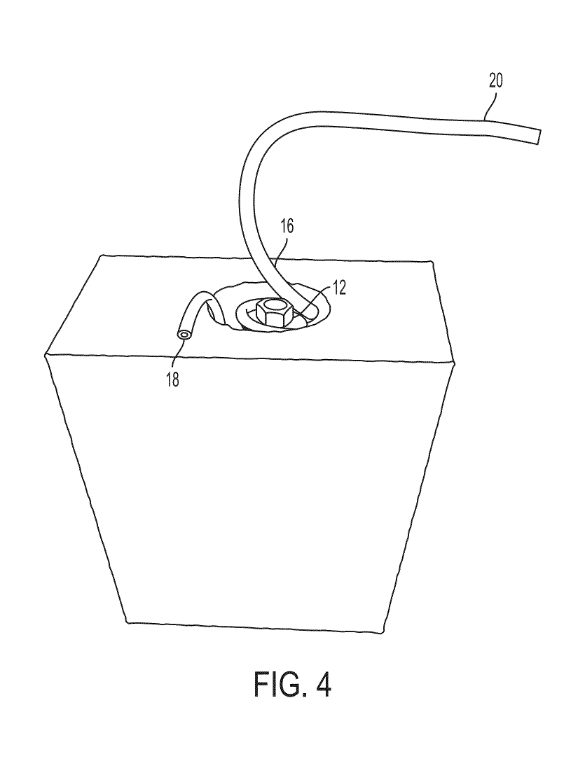

In this example, a concrete block with a formed 3.5″ diameter hole was filled with water, acting as a first fluid, with a depth equal to about 10″. A threaded rod 10 (length about equal to the height of the water), acting as an elongated element, with washers 12 and 14 (Diameter equal to about 2″) secured at the top and bottom of the rod, acting as a first end and second end of the elongated element, is shown in FIG. 3. The rod and washers were wrapped with a ⅜″ O.D. copper tubing coil 16, acting as a conduit, from top to bottom with a first end 18 of the coil extended upward past the coils and past the top washer 12. The rod 10 and copper coil 16 apparatus was inserted into the concrete hole filled with water, as shown in FIG. 4.

In this example, the second end of the coil 20 was connected to a liquid nitrogen tank, acting as a second fluid. In this example liquid nitrogen is delivered through the coil, but, in other embodiments any material can be introduced through the coil such that the material causes the liquid within intermediate portion between the first end and second end of the elongated element to freeze or substantially freeze.

A valve of the liquid nitrogen tank was opened to allow the liquid nitrogen to run through the coil 16 and exit the coil through the first end 18. In this example the liquid nitrogen exits the first end 18, but in other embodiments, the liquid nitrogen could be recirculated after passing through the first end 18.

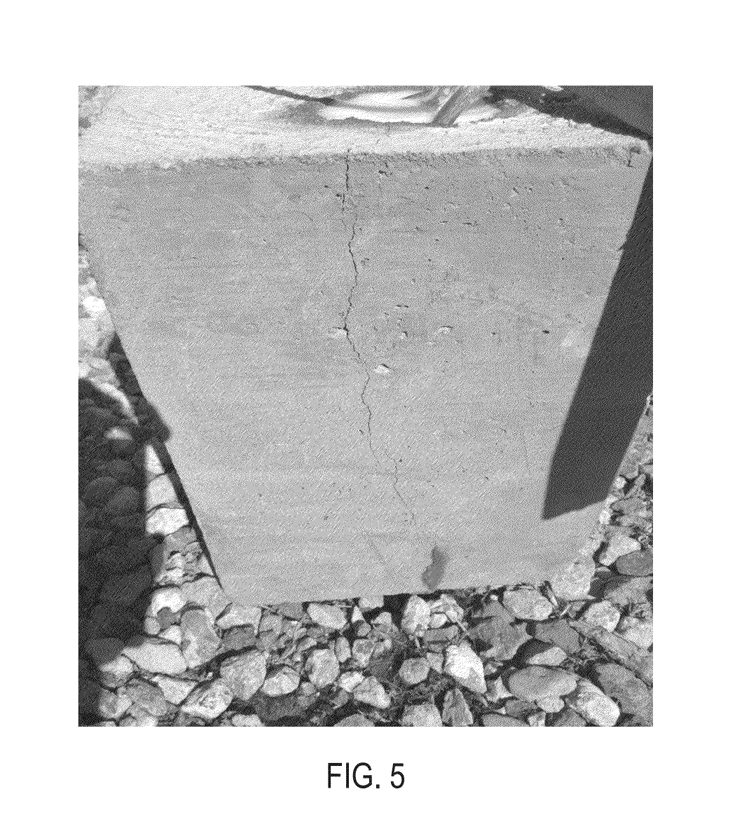

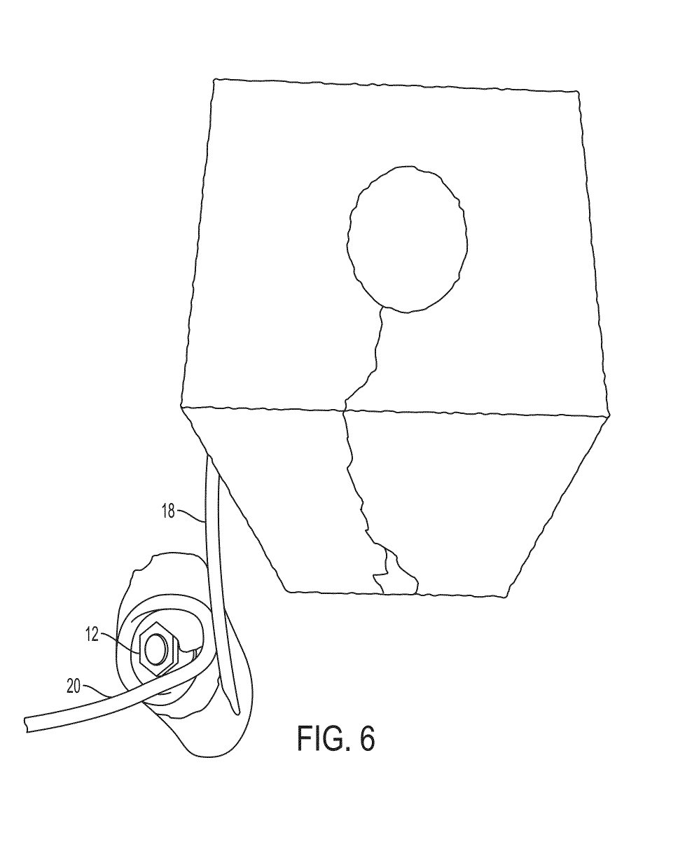

After about 90 minutes, the coil created a zone of substantially frozen water within the hole, between washer 12 and washer 14, which caused the ice to expand horizontally and crack the concrete block as shown in FIG. 5. The washers 12 and 14 and threaded rod 10 substantially prevented the ice from expanding vertically out of the hole. As shown in FIG. 6, the substantially frozen zone around the coil 20 and rod 10 can be seen once the coil has been removed from the block.

### EXAMPLE 3

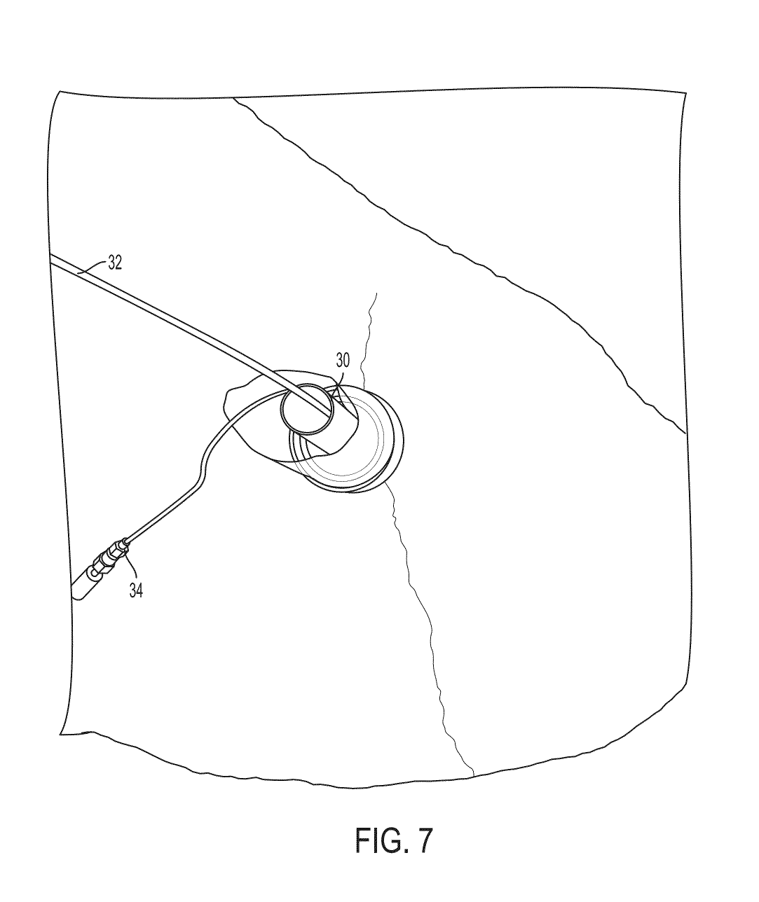

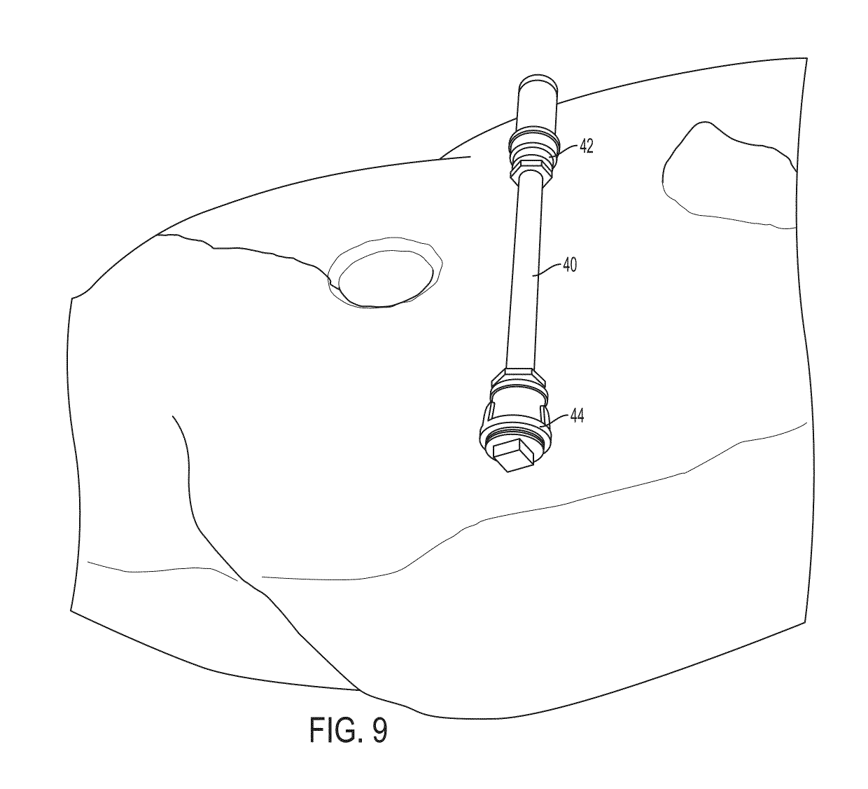

In this example, a rock boulder 31 was drilled to form a 5″ diameter hole with a depth of about 22″. A 1″ diameter pipe 30, acting as an elongated member, (length about equal to the height of the water) with pipe flanges, acting as a first and second end, (not shown in FIG. 7, diameter equal to 4″(best shown in FIG. 9)) secured at the top and bottom of the pipe were wrapped with a copper tubing coil, acting as a conduit, from top to bottom with a first end 32 of the coil turned upward through the center of the pipe 30 and past the top flange. The pipe 30 and copper coil apparatus was inserted into the drilled rock hole filled and the hole was filled with water, acting as a first fluid, such that the water fills up or substantially fills up the intermediate portion between the flanges.

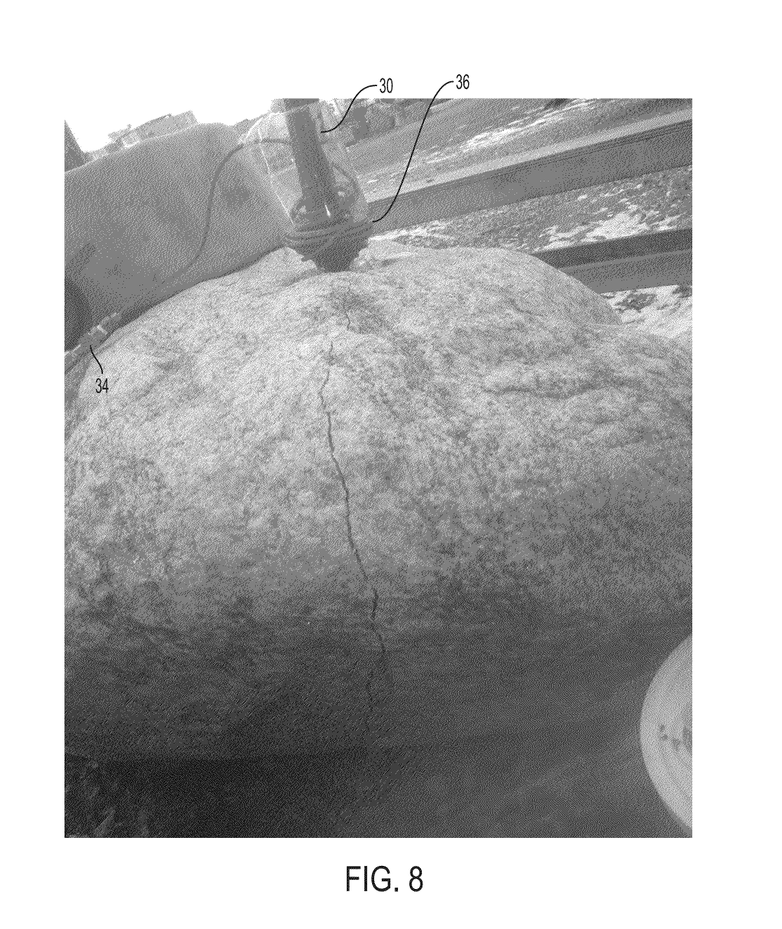

In this example, the second end of the coil 34 was connected to a liquid nitrogen tank. A valve at the pressurized tank was opened to allow the liquid nitrogen, acting as a second liquid, to run through the coil and exit through the first end 32. After about 120 minutes, the coil created a zone of frozen water within the hole in an intermediate portion between the flanges, which expanded horizontally and cracked the boulder, as shown in FIG. 8. The flanges, including flange 36 and pipe 30 substantially prevented the ice from expanding vertically.

### EXAMPLE 4

In another embodiment shown in FIG. 9, a pipe 40 is shown with two flanges, 42 and 44, one on each end of the pipe 40. In this figure the pipe 40 is shown without the coil.

### EXAMPLE 5

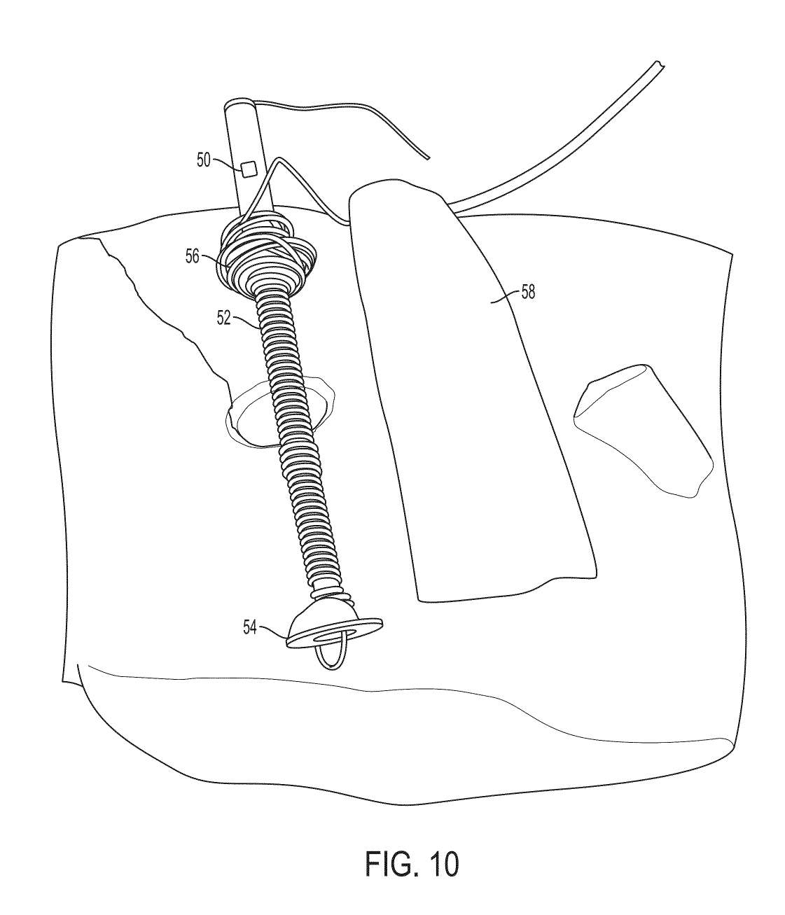

In another embodiment, a pipe 50, acting as an elongated member, is shown in FIG. 10. Pipe 50 is wrapped with a copper coil 52, acting as a conduit, and includes two flanges 54 and 56, acting as the first end and second end of the elongated member, one on either end of the pipe 50. Also shown in FIG. 10 is a sleeve (in this example a section of a fire hose) 58. This sleeve 58 can be placed between the pipe 50 and the inner face of the hole to reduce water from leaching or dispersing into the rock the hole is formed in. The inclusion of a substantially pressure resistant yet substantially elastic material, for example in this embodiment a fire hose, is optional.

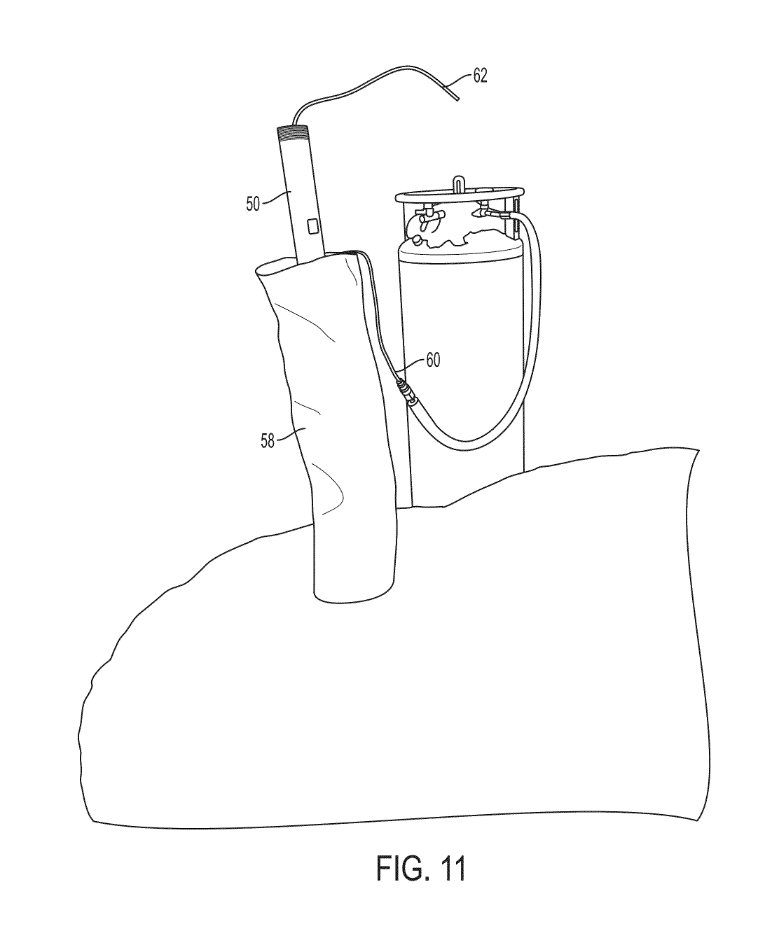

FIG. 11 illustrates the pipe 50 shown in FIG. 10 with the hose 58 placed over the pipe 50 and coil, prior to the apparatus (including the pipe, coil and hose) being lowered into the formed hole. Liquid nitrogen, acting as the second fluid, entered into the coil through the first end 60, passed through the coil and exited the second end of the coil 62.

Other embodiments of the apparatus and method are contemplated. Other embodiments of the disclosure could include coils formed of different materials and having different diameters. Further, additives could be added to the water to change its properties, for example, to increase the viscosity of the water.

As described above the top of the threaded bolt or the top of the pipe acted as a restrictor for vertical expansion of the water, but in other embodiments, other mechanical devices could be used or the top of the bore hole could include water and be frozen initially to restrict vertical expansion of the remaining water. Although water is described herein as the liquid being frozen, any liquid that expands upon freezing, including mixtures of liquids, could be used. Also as described herein liquid nitrogen is used as the refrigerant freezing the water, any other liquid refrigerant or refrigerants that can maintain temperatures below freezing can be used.

The described embodiments and examples of the present disclosure are intended to be illustrative rather than restrictive, and are not intended to represent every embodiment or example of the present disclosure. While the fundamental novel features of the disclosure as applied to various specific embodiments thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should he recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

1. An apparatus configured to fracture a solid matter, the apparatus comprising:
an elongated element, the elongated element comprising a first end and a second end,
wherein at least one of the first end and the second end are wider than the elongated element and wherein an intermediate portion of the elongated element is formed between the first end and the second end, wherein the intermediate portion is configured to contain a first liquid between the solid matter and the elongated element; and
a conduit configured to convey a second fluid, wherein the second fluid is at a temperature below a freezing temperature of the first fluid, wherein a portion of the conduit passes through the intermediate portion.

2. The apparatus of claim 1, wherein the first fluid is water.

3. The apparatus of claim 1, wherein the second fluid is liquid nitrogen.

4. The apparatus of claim 1, further comprising a sleeve configured to extend between the elongated element and the solid matter.

5. A method for fracturing a solid matter, the method comprising the steps of:
inserting an elongated element into an opening of the solid matter the elongated element comprising a first end and a second end, wherein at least one of the first end and the second end are wider than the elongated element and wherein an intent intennediate portion of the elongated element is formed between the first end and the second end, wherein the intermediate portion is configured to contain a first liquid between the solid matter and the elongated element; and
conveying a second fluid through a conduit for a period of time, wherein the second fluid is at a temperature below a freezing temperature of the first fluid and wherein a portion of the conduit passes through the intermediate portion.

6. The method of claim 5, wherein the first fluid is water.

7. The method of claim 5, wherein the second fluid is liquid nitrogen.

8. The method of claim 5, further comprising a step of inserting a sleeve over the elongated element prior to the step of conveying the second fluid, the sleeve configured to extend between the elongated element and the solid matter.
